(19) United States
(12) Patent Application Publication
(10) Pub. No.: US 2023/0359237 A1
(43) Pub. Date: Nov. 9, 2023

(54) DRUM TACTILE FEEDBACK DEVICE STEERING UNIT AND METHOD

(71) Applicant: LORD Corporation, Cary, NC (US)

(72) Inventor: Michael Jarzomski, Apex, NC (US)

(21) Appl. No.: 18/029,800

(22) PCT Filed: Oct. 15, 2021
(86) PCT No.: PCT/US2021/055136

§ 371 Date: Mar. 31, 2023

Related U.S. Application Data
(60) Provisional application No. 63/092,046, filed on Oct. 15, 2020.

(51) Int. Cl. G05G 5/03; F16D 57/00; H02K 1/22; H02K 7/00; H02K 11/21; H02K 7/10

(52) U.S. Cl. CPC G05G 5/03; F16D 57/002; H02K 1/22; H02K 7/003; H02K 11/21; H02K 7/10; F16D 2200/0034; G05G 2505/00; F16D 2121/18

(57) ABSTRACT

A tactile feedback device (TFD) drum brake has a drum rotor that creates at least two gaps and at least four shear surfaces. Magnetically responsive (MR) material is disposed within the gaps. The TFD drum brake further has an upper and lower magnetic seal to prevent the migration of the MR material from the gaps. The drum rotor is thin and rapidly saturates when a magnetic flux is generated. Controllable torque is created when the drum rotor is saturated. The controllable torque provides feedback to an operator of vehicle with the TFD drum brake installed.

### CROSS-REFERENCE TO RELATED APPLICATIONS

The present application claims the benefit of U.S. Provisional Patent Application Ser. No. 63/092,046, filed on Oct. 15, 2020, and entitled “DRUM TACTILE FEEDBACK DEVICE STEERING UNIT AND METHOD,” the disclosure of which is incorporated herein by reference in its entirety.

### FIELD OF INVENTION/BACKGROUND

The subject matter herein generally relates to the field of resistive torque-generating devices and systems (e.g., brakes, locks, clutches, tactile feedback devices, resistance-generating devices, motion control devices, and the like). More particularly, the subject matter herein relates to tactile feedback device (TFD) drum brakes using magnetically responsive (MR) material to generate resistive torque.

### BACKGROUND

Existing magnetically responsive (MR) devices such as disk rotor brakes and drum brakes have a gap between the rotor and the coil which creates shear surfaces. Existing drum brakes do not have and cannot support more than two shear surfaces. Torque is limited to the size of the device and the available shear surface. Additionally, existing MR devices using a MR material require expensive seals to prevent the migration of the MR material from the gap into the remainder of the device. What is needed is an MR drum that is smaller than the existing devices and that provides greater torque. Also, what is needed is an MR drum brake that has improved seals to prevent migration of the MR material.

### SUMMARY OF THE INVENTION

In one aspect, a tactile feedback device (TFD) drum brake is provided. The TFD drum brake comprises a shaft, a drum rotor, a core, a pole ring, a magnetically responsive (MR) material, an upper magnetic seal, a lower magnetic seal, at least one sensor, and a housing enclosing the foregoing. The shaft has a rotation disk rotatably connected thereto. The drum rotor is connected to the rotation disk. The core has an integrated coil positioned radially inward from the drum rotor and forms a first gap therebetween. The pole ring is fixedly positioned radially outward from the drum rotor and forms a second gap therebetween. The MR material is disposed within the first gap and the second gap. The upper magnetic seal is positioned to block MR material from moving from the second gap. The lower magnetic seal is positioned to block MR material from moving from the first gap. The housing encloses the shaft, the drum rotor, the core, the upper magnetic seal, and the lower magnetic seal. The housing has a housing cap and a sensor housing secured thereto. The at least one sensor is capable of detecting rotation of the shaft.

In another aspect, a TFD drum brake is provided. The TFD drum brake comprises a shaft, a drum rotor, a pole ring, a core, a rotation disk, an upper magnetic seal, a lower magnetic seal, a MR material, at least one sensor, and a housing enclosing the foregoing. The drum rotor has a first brake shear surface and a second brake shear surface, wherein the first brake shear surface is on a rotor inner surface (RIS) of the drum rotor and the second brake shear surface is on a rotor outer surface (ROS) of the drum rotor. The pole ring has a pole ring shear surface on a pole ring inner surface (PRIS) fixedly and oppositely positioned from the ROS, wherein a second gap is positioned between the PRIS and the ROS. The core has an integrated coil. The core has a core shear surface on a core outer surface (COS) oppositely positioned from the RIS, wherein a first gap is positioned between the COS and the RIS. The rotation disk has an end, wherein the drum rotor is connected to the end and the rotation disk is rotatably connected to a shaft. The MR material is disposed within the first gap and the second gap. The housing includes a housing cap secured to a housing wall at housing top edge of the housing wall. The housing also includes a sensor housing secured to the housing wall at a housing bottom edge of the housing wall. The upper magnetic seal is positioned to block movement of the MR material from the first gap past an upper void between the upper magnetic seal and the housing cap. The lower magnetic seal is positioned to block movement of the MR material from the second gap past a lower void between lower magnetic seal and the core.

In yet another aspect, a method of providing tactile feedback using TFD drum brake 10 is provided. The method comprises generating torque with TFD drum brake, energizing an integrated coil by applying current to the integrated coil, magnetically saturating a drum rotor, and generating a resistive torque. The drum brake includes a housing which encloses a shaft, a drum rotor, a pole ring, a core, a rotation disk, an upper magnetic seal, a lower magnetic seal, a MR material, and at least one sensor. The drum rotor has a first brake shear surface and a second brake shear surface. The first brake shear surface is on a rotor inner surface (RIS) of the drum rotor and the second brake shear surface is on a rotor outer surface (ROS) of the drum rotor. The pole ring has a pole ring shear surface on the pole ring inner surface (PRIS) fixedly and oppositely positioned from the ROS. The second gap is positioned between the PRIS and the ROS. The core has the integrated coil and a core shear surface on core outer surface (COS) that is oppositely positioned from RIS. The first gap is positioned between the COS and RIS. The rotation disk has an end. The drum rotor is connected to the end and the rotation disk is rotatably connected to the shaft. The MR material is disposed within the first gap and the second gap. The housing includes a housing cap secured to the housing wall at a housing top edge of the housing wall. The housing also includes a sensor housing secured to the housing wall at a housing bottom edge of the housing wall.

The upper magnetic seal is positioned to block movement of MR material from the first gap past an upper void between the upper magnetic seal and the housing cap. The lower magnetic seal is positioned to block movement of the MR material from the second gap past lower void between the lower magnetic seal and the core.

The TFD drum brake is controlled by a controller. The controller is in electronic communication with the at least one sensor. A power source generates a current. The power source is in electrical communication with the integrated coil. The controller is capable of controlling the current from the power source and the magnetic flux is generated as a result of the current being communicated to the integrated coil.

A circuit is provided that is capable of saturating the drum rotor with the magnetic flux. The circuit includes the core, the first gap with the MR material disposed therein, the drum rotor, the second gap with the MR material disposed therein, and the pole ring. The drum rotor saturates when the magnetic flux passes through the circuit and when the magnetic flux reaches a threshold of about 1.3 Tesla (T).

The method step of energizing the integrated coil by applying current to the integrated coil, generates the magnetic flux. The method step of magnetically saturating the drum rotor occurs with the generation of the magnetic flux. The step of magnetically saturating the drum rotor causes the first brake shear surface and the second brake shear surface of the drum rotor to shear against the MR material and each of the pole ring shear surface and the core shear surface. The method step of generating the resistive torque, includes the shearing of the MR material against the first brake shear surface, the second brake shear surface, the pole ring shear surface, and the core shear surface to create the resistive torque.

### BRIEF DESCRIPTION OF THE DRAWINGS

FIGS. 1a and 1b depict a perspective view of a tactile feedback device (TFD) drum brake.

FIGS. 2a and 2b depict a section view of the TFD drum brake from FIGS. 1a and 1b.

FIG. 3 is a detail view of the upper half of the TFD drum brake from FIGS. 2a and 2b.

FIG. 4 is a detail view of the magnetic seal from FIGS. 2a and 2b.

FIG. 5 is a schematic view of the magnetic flux of the TFD drum brake from FIGS. 2a and 2b.

FIG. 6 is a section view of the TFD drum brake from FIGS. 1a and 1b with a different magnetic seal configuration.

FIG. 7 is a detail view of the magnetic seal from FIG. 6.

FIG. 8 is a schematic view of the magnetic flux of the TFD drum brake from FIG. 6.

### DETAILED DESCRIPTION

Vehicles typically have a steering column and a steering wheel to enable steering the vehicle. Many types of vehicles such as cars, trucks, off-road equipment, watercraft, etc. now use steer-by-wire technology and require the use of feedback to the operator to give the sensation of resistance as the steering wheel is turned. As used, the term steering wheel encompasses a standard wheel, or anything that rotates. The feedback is provided by a tactile feedback device (TFD). In the invention disclosed herein, the TFD is a TFD drum brake.

A typical magnetically responsive (MR) disk brake or a typical drum brake do not provide for radial compactness. A TFD drum brake as disclosed herein provides the benefits of a drum brake, but also adds a substantially increased torque provided by the MR material disposed within the TFD drum brake.

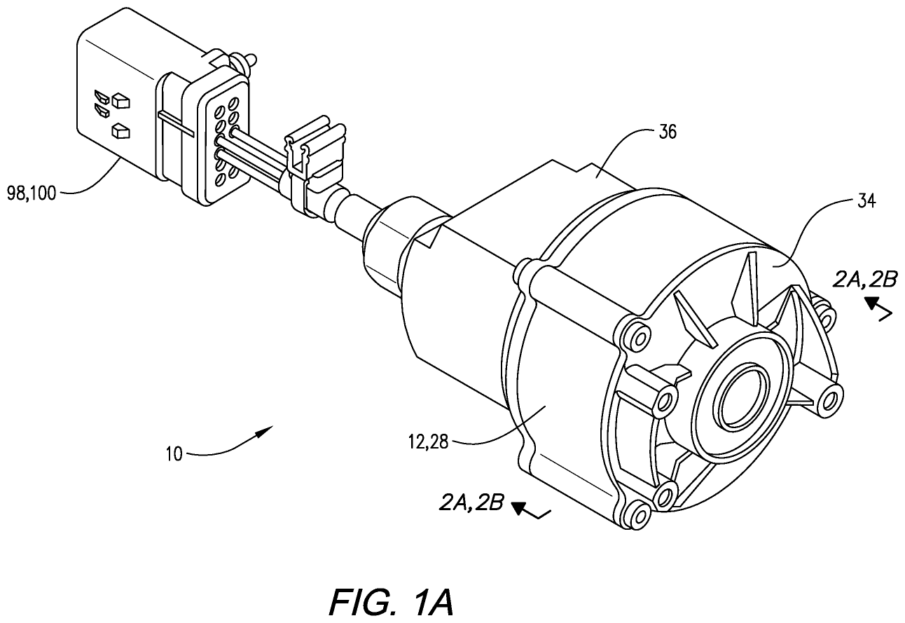

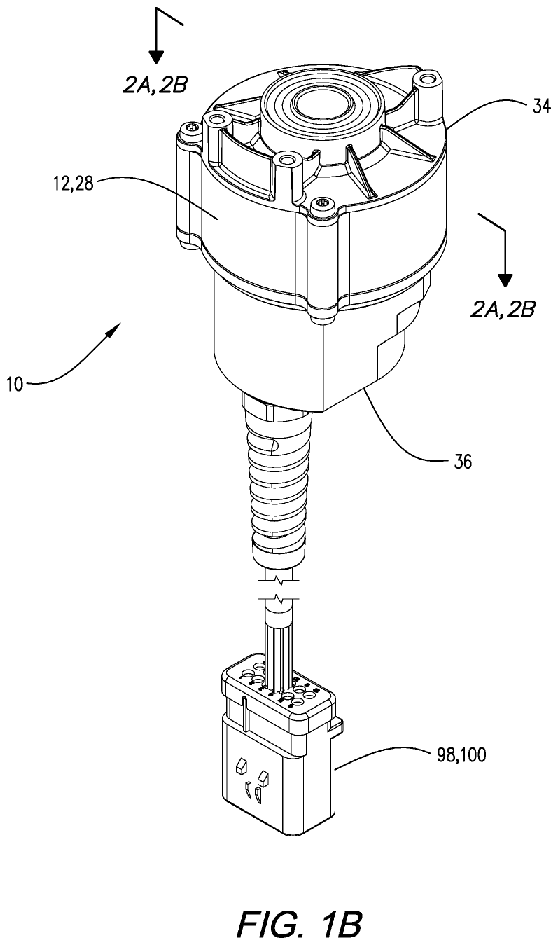

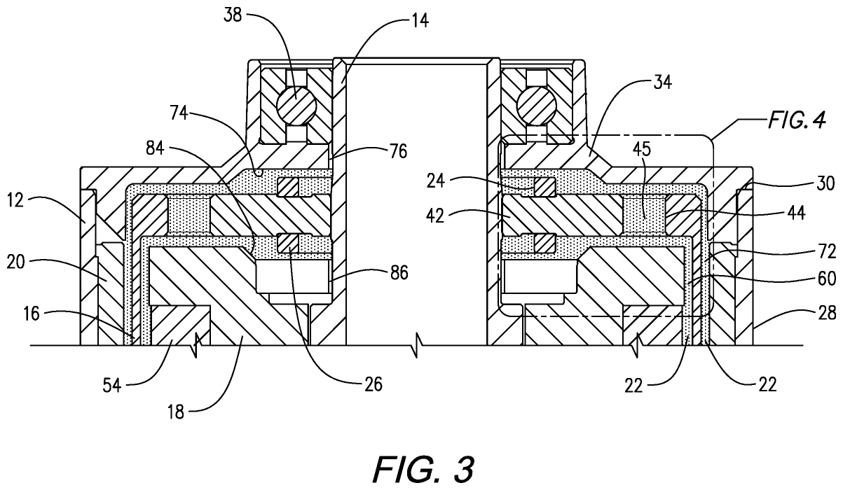

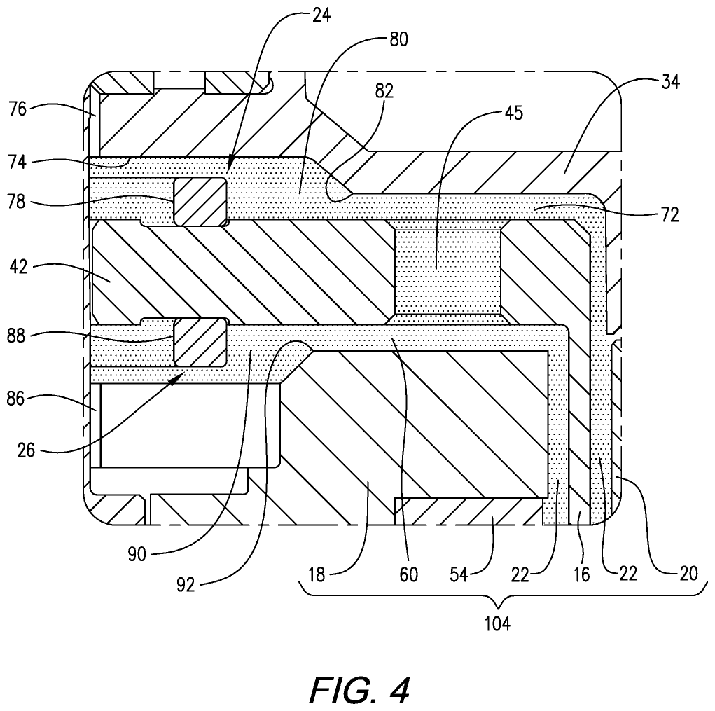

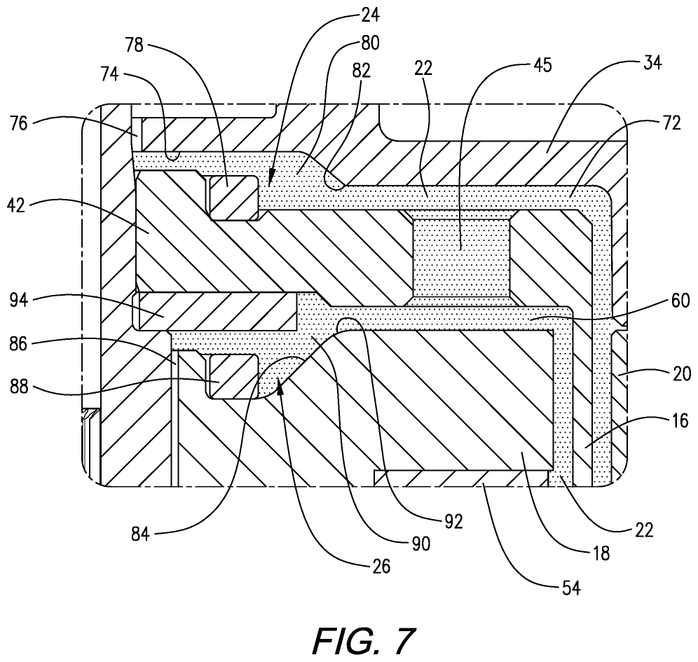

Referring to the drawings, FIGS. 1-8 depict a tactile feedback device (TFD) drum brake generally designated as TFD drum brake 10. TFD drum brake 10 comprises housing 12 enclosing shaft 14, drum rotor 16, core 18, pole ring 20, MR material 22, upper magnetic seal 24, and lower magnetic seal 26 within. Housing 12 includes housing wall 28. Housing wall 28 includes housing top edge 30 and housing bottom edge 32. Housing cap 34 is secured to housing top edge 30. Housing cap 34 is made from a non-magnetic material (e.g., 6061-T6 Aluminum or similar material). Sensor housing 36 encloses drive electronics (not shown) for TFD drum brake 10 and is secured to housing bottom edge 32.

Shaft 14 is rotatably disposed within housing 12. Shaft 14 is rotatably supported by upper bearings 38 and lower bearings 40. Shaft 14 has rotation disk 42 attached thereto and extending radially outward therefrom. Drum rotor 16 is connected to rotation disk 42 at end 44 of rotation disk 42 and rotates with shaft 14. As illustrated in FIGS. 1-3 drum rotor 16 extends radially outward from end 44 and is perpendicular to shaft 14 before it bends parallel to shaft 14 and perpendicular to rotation disk 42. It is understood that rotation disk 42 can extend radially outward and drum rotor 16 can only be parallel to shaft 14. Additionally, drum rotor 16 and rotational disk 42 can be a single component directly affixed to shaft 14. In one embodiment, drum rotor 16 has a thickness between about 0.5 millimeters to about 5 millimeters. In another embodiment, drum rotor 16 has a thickness of about 0.5 millimeters to about 1.5 millimeters.

First brake shear surface 46 is on rotor inner surface (RIS) 48 of drum rotor 16, and second brake shear surface 50 that is on rotor outer surface (ROS) 52 on drum rotor 16. MS 48 faces radially inward and ROS 52 faces radially outward.

Core 18 is disposed about shaft 14 and is not rotatable relative to shaft 14. Core 18 is positioned radially inward from drum rotor 16. Core 18 includes integrated coil 54. Core 18 has core shear surface 56 on core outer surface (COS) 58 that is radially inward and oppositely positioned from RIS 48. The space between COS 58 and RIS 48 forms first gap 60 therebetween. MR material 22 is disposed within first gap 60.

Pole ring 20 is positioned and secured radially outward from drum rotor 16 and is secured between cap lower edge 62, lower seat 64 of housing wall 28, and wall inner surface 66. Pole ring 20 is fixedly positioned radially outward from drum rotor 16. Pole ring 20 has pole ring shear surface 68 on pole ring inner surface (PRIS) 70. PRIS 70 is radially outward and oppositely positioned from ROS 52. The space between ROS 52 and PRIS 70 forms second gap 72 therebetween. MR material 22 is also disposed within second gap 72. Flow hole 45 is positioned proximate end 44 and is part of rotation disk 42. Flow hole 45 allows for MR material 22 to flow between first gap 60 and second gap 72.

In one embodiment, first gap 60 and second gap 72 each have a width of about 0.5 millimeters to about 2.0 millimeters. In another embodiment, first gap 60 and second gap 72 each have a width of about 0.5 millimeters to about 1.0 millimeters.

Referring to FIGS. 1-4, upper magnetic seal 24 is positioned between second gap 72, rotation disk 42, and lower edge 74 of housing cap 34, where upper void 76 is formed therebetween. Upper magnetic seal 24 is positioned to prevent or block MR material 22 from moving from second gap 72. Upper magnetic seal 24 includes permanent magnet 78. Permanent magnet 78 is affixed to and rotates with rotation disk 42. Upper opening 80 is positioned between upper void edge 82 of second gap 72 and permanent magnet 78. Upper magnetic seal 24 prevents MR material 22 from entering upper void 76 through upper opening 80 and contaminating upper bearings 38.

Lower magnetic seal 26 is positioned between first gap 60, rotation disk 42, and upper edge 84 of core 18, where lower void 86 is formed therebetween. Lower magnetic seal 26 includes second permanent magnet 88. Lower magnetic seal 26 is positioned to prevent or block MR material 22 from moving from first gap 60. Second permanent magnet 88 is affixed to and rotates with rotation disk 42. Lower opening 90 is positioned between lower void edge 92 of first gap 60 and second permanent magnet 88. Lower magnetic seal 26 prevents MR material 22 from entering lower void 86 and contaminating lower bearings 40.

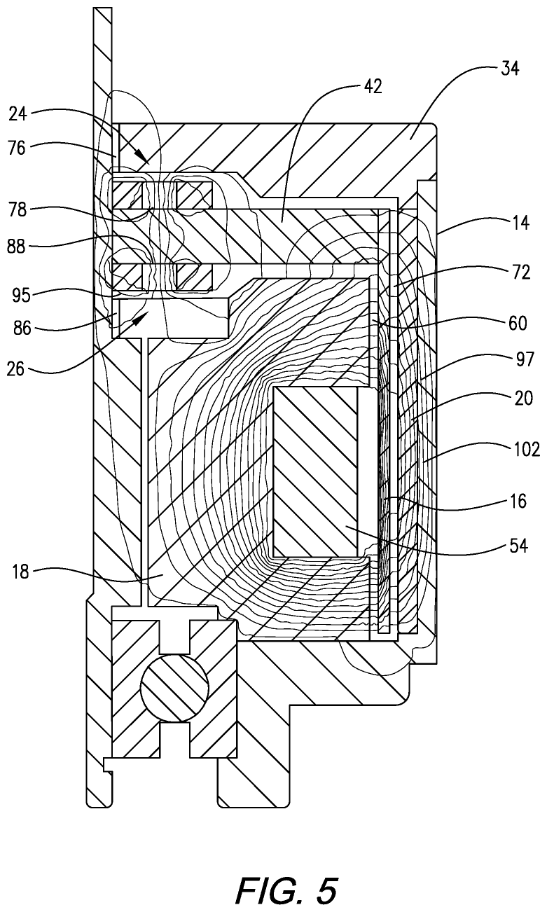

In an alternative embodiment illustrated in FIG. 5-8, lower magnetic seal 26 is positioned affixed adjacent core 18 with second permanent magnet 88 affixed to core 18. Lower void 86 is positioned between non-magnetic washer 94 and lower opening 90. Non-magnetic washer 94 is positioned affixed to and rotates with rotation disk 42.

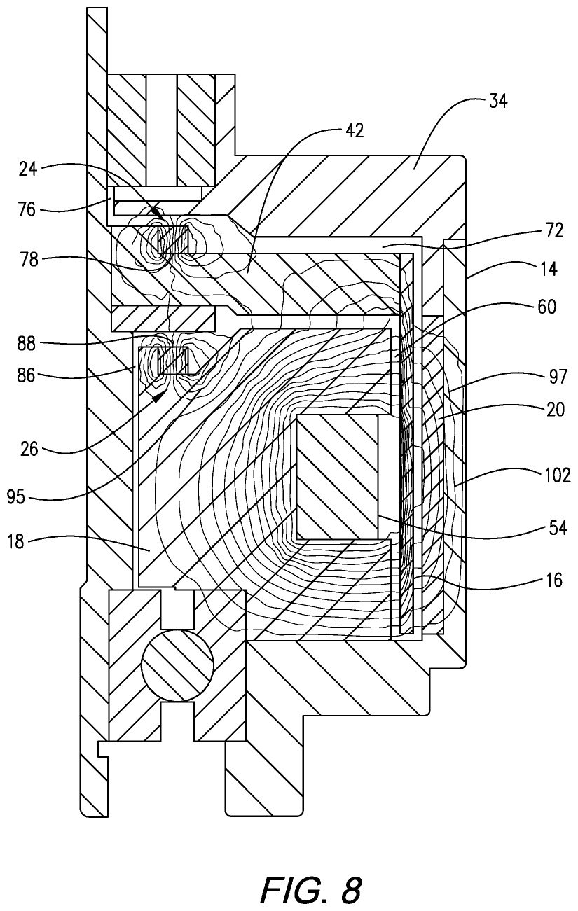

As illustrated in FIGS. 5 and 8, polarity 95 of lower magnetic seal 26 in all embodiments is opposite of polarity 97 of pole ring 20. Rotation disk 42 provides the magnetic flux path for both upper magnetic seal 24 and lower magnetic seal 26.

Referring to FIGS. 1-8, MR material 22 is a dry magnetically responsive powder including magnetizable particles that are not dispersed within a liquid or oil carrier. The magnetizable particles of material may include carbonyl iron, stainless steel, and/or any other magnetic material having various shapes, not limited to a spherical shape. MR material 22 is configured to provide smooth torque that is proportional to current, and it is independent of temperature.

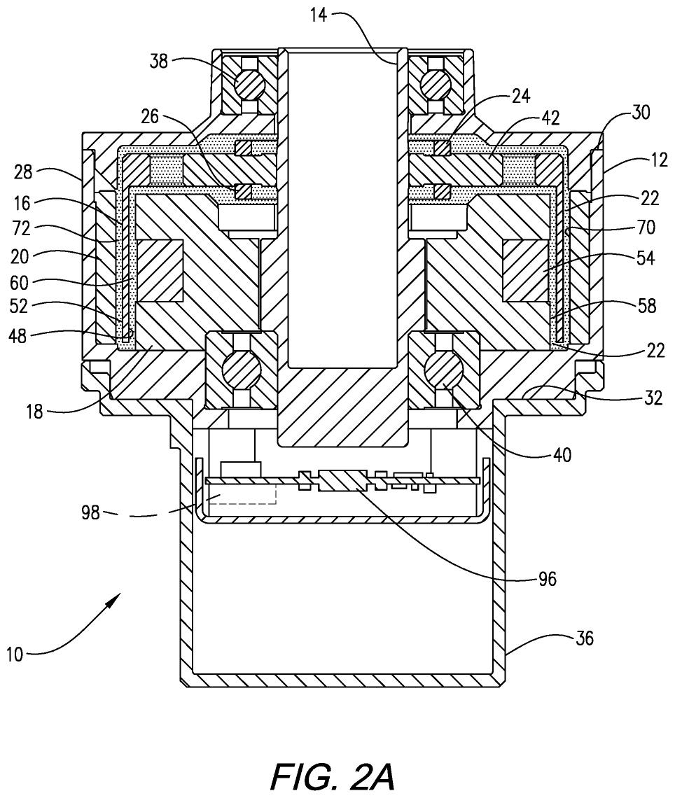

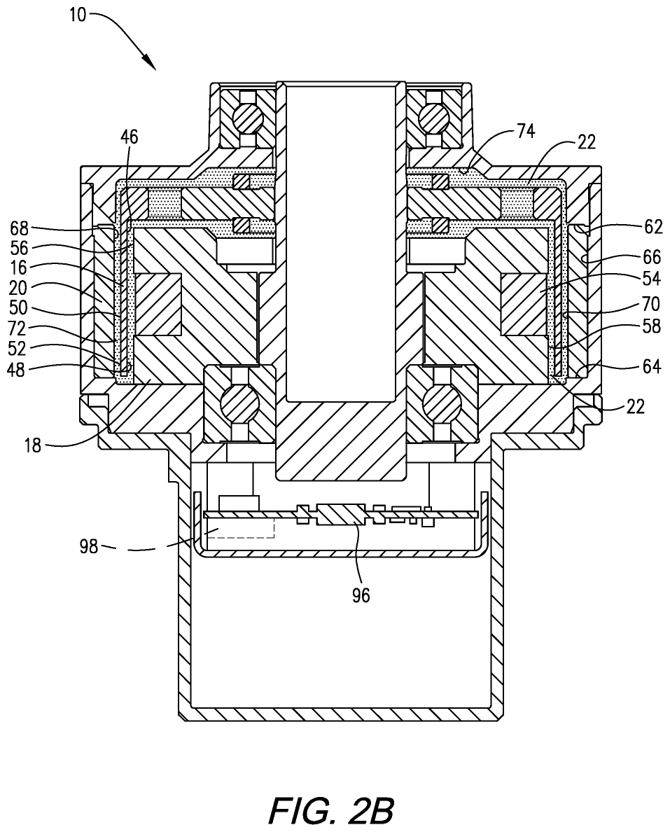

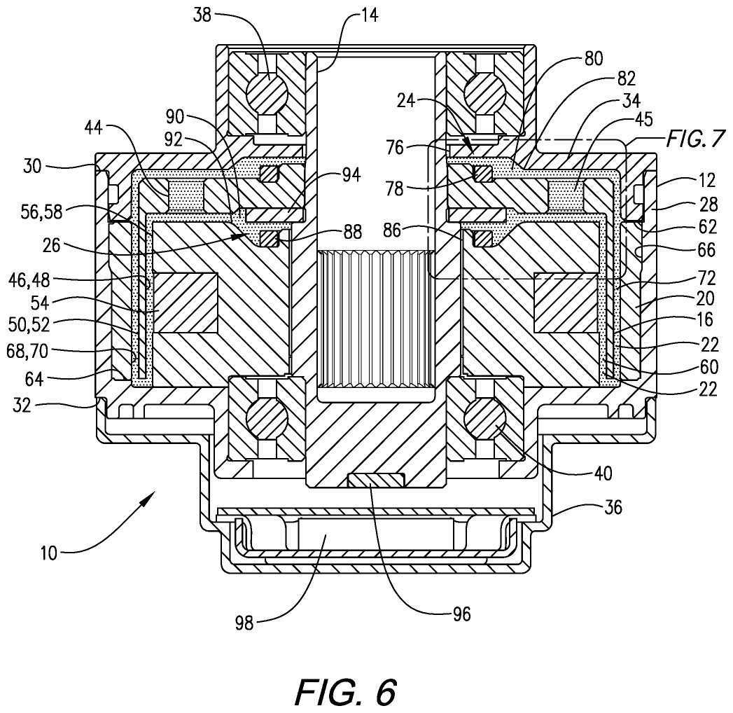

As illustrated in FIGS. 2a, 2b, and 6, at least one sensor 96 is positioned to monitor rotation of shaft 14.

Referring to FIGS. 1a-2b and 6, controller 98 and power source 100 are included with TFD drum brake 10. Power source 100 is capable of generating a current (not shown) and directly or indirectly electrically communicates the current to integrated coil 54. Power source 100 is externally positioned from TFD drum brake 10. Controller 98 is at least in electronic communication with at least one sensor 96, integrated coil 54, and power source 100. Controller may include a current amplifier (not shown) and at least one temperature sensor (not shown).

Controller 98 is capable of controlling the current from power source 100 used to energize integrated coil 54 and generate magnetic flux 102. The control is provided by using algorithms related to end-stop torque to simulate the end of travel or to torque for creating the tactile feedback based upon inputs such as steering effort, vehicle speed, and other operating functions. The control also includes processing data at least from sensor 96 related to the rotation of shaft 14.

Controller 98 increases or decreases the current from power source 100 that is electrically communicated to integrated coil 54. When the current amplifier is included, the current is controlled by the current amplifier, and it is capable of increasing or decreasing the current electrically communicated to integrated coil 54. The current amplifier is used when controller 98 is integrally positioned within sensor housing 36 of TFD drum brake 10. The current amplifier may be used when controller 98 is externally positioned from sensor housing 36 of TFD drum brake 10.

Referring to FIGS. 5 and 8, magnetic flux 102 is generated when integrated coil 54 is energized with the current. Circuit 104 includes core 18, first gap 60 with MR material 22 disposed therein, drum rotor 16, second gap 72 with MR material 22 disposed therein, and pole ring 20. Magnetic flux 102 passes through circuit 104 and saturates drum rotor 16. Stated another way, controller 98 is capable of saturating drum rotor 16 with magnetic flux 102 generated by applying the current to integrated coil 54. Magnetic flux 102 causes the MR material 22 to create shear between the core shear surface 56 and the first brake shear surface 46, and between second brake shear surface 50 and pole ring shear surface 68. The effect of shearing due to is the creation of torque in TFD drum brake 10.

TFD drum brake 10 may be used on a vehicle (not shown). Vehicles typically have a steering column (not shown) and a steering wheel (not shown) to enable steering the vehicle. As discussed above, many vehicles now use steer-by-wire technology and require the use of a feedback to the operator of the vehicle to give the sensation of resistance as the steering wheel is turned. For vehicles with a steering column, TFD drum brake 10 enclosed therein. Shaft 15 of TFD drum brake 10 is capable of transmitting a feedback force to the operator through the steering wheel.

In an embodiment, a method of providing tactile feedback using TFD drum brake 10 is provided. The method comprises generating torque with TFD drum brake 10 described above, energizing integrated coil 54 by applying current to integrated coil 54, magnetically saturating drum rotor 16, and generating a resistive torque.

The drum brake is described above and includes housing 12 which encloses shaft 14, drum rotor 16, pole ring 20, core 18, rotation disk 42, upper magnetic seal 24, lower magnetic seal 26, MR material 22, and at least one sensor 96. Drum rotor 16 has first brake shear surface 46 and second brake shear surface 50. First brake shear surface 46 is on rotor inner surface (RIS) 48 of drum rotor 16 and second brake shear surface 50 is on rotor outer surface (ROS) 52 of drum rotor 16. Pole ring 20 has pole ring shear surface 68 on pole ring inner surface (PRIS) 70 fixedly and oppositely positioned from ROS 52. Second gap 72 is positioned between PRIS 70 and ROS 52. Core 18 has integrated coil 54 and core shear surface 56 on core outer surface (COS) 58 oppositely positioned from RIS 48. First gap 60 is positioned between the COS (58) and RIS 48. Rotation disk 42 has end 44. Drum rotor 16 is connected to end 44 and rotation disk 42 is rotatably connected to shaft 14. MR material 22 is disposed within first gap 60 and second gap 72. Housing 12 includes housing cap 34 secured to housing wall 28 at housing top edge 30 of housing wall 28. Housing 12 also includes sensor housing 36 secured to housing wall 28 at housing bottom edge 32 of housing wall 28.

Upper magnetic seal 24 is positioned to trap MR material in upper void 76 and to block movement of MR material 22 from first gap 60 past upper void 76 between upper magnetic seal 24 and housing cap 34. Lower magnetic seal 26 is positioned to trap MR material in lower void 86 and to block movement of MR material 22 from second gap 72 past lower void 86 between lower magnetic seal 26 and core 18. TFD drum brake 10 also includes at least one sensor 96.

TFD drum brake 10 is controlled by controller 98. Controller 98 is in electronic communication with at least one sensor. Power source 100 generates a current. Power source 100 is in electrical communication with integrated coil 54. Controller 98 is capable of controlling the current from power source 100 and magnetic flux 102 generated as a result of current being communicated to integrated coil 54.

Circuit 104 is capable of saturating drum rotor 16 with magnetic flux 102. Circuit 104 includes core 18, first gap 60 with MR material 22 disposed therein, drum rotor 16, second gap 72 with MR material 22 disposed therein, and pole ring 20. Drum rotor 16 saturates when magnetic flux 102 passes through circuit 104.

The method step of energizing integrated coil 54 by applying current to integrated coil 54, generates magnetic flux 102.

The method step of magnetically saturating drum rotor 16 occurs with the generation of magnetic flux 102. The step of magnetically saturating drum rotor 16 causes first brake shear surface 46 and second brake shear surface 50 of drum rotor 16 to shear against MR material 22 and each of pole ring shear surface 68 and core shear surface 56.

The method step of generating the resistive torque, includes the shearing of the MR material 22 against first brake shear surface 46, second brake shear surface 50, pole ring shear surface 68, and the core shear surface 56 to create the resistive torque.

Other embodiments of the present invention will be apparent to one skilled in the art. As such, the foregoing description merely enables and describes the general uses and methods of the present invention. Accordingly, the following claims define the true scope of the present invention.

1. A tactile feedback device (TFD) drum brake comprising:
a shaft having a rotation disk rotatably connected thereto;
a drum rotor connected to the rotation disk;
a core having an integrated coil positioned radially inward from the drum rotor forming a first gap therebetween;
a pole ring fixedly positioned radially outward from the drum rotor forming a second gap therebetween;
a magnetically responsive (MR) material disposed within the first gap and the second gap;
an upper magnetic seal positioned to block the MR material moving from the second gap;
a lower magnetic seal positioned to block the MR material moving from the first gap;
a housing enclosing the shaft, the drum rotor, the core, the upper magnetic seal, and the lower magnetic seal, the housing having a housing cap and a sensor housing secured thereto; and
at least one sensor capable of detecting a rotation of the shaft.

2. The TFD drum brake of claim 1, further comprising a controller and an external power source, wherein the controller is in electronic communication with the at least one sensor, the integrated coil, and the external power source, and the external power source is capable of generating a current, wherein the external power source is in electrical communication with the integrated coil, wherein the controller is capable of controlling the current from the external power source and a magnetic flux generated by the integrated coil.

3. The TFD drum brake of claim 2, further comprising a circuit capable of saturating the drum rotor with the magnetic flux, wherein the circuit includes the core, the first gap with the MR material disposed therein, the drum rotor, the second gap with the MR material disposed therein, and the pole ring, wherein the drum rotor saturates when the magnetic flux passes through the circuit.

4. The TFD drum brake of claim 2, wherein the controller is integrally positioned within the sensor housing of the TFD drum brake.

5. The TFD drum brake of claim 2, wherein the controller includes a current amplifier and is capable of increasing or decreasing the current electrically communicated to the integrated coil.

6. (canceled)

7. The TFD drum brake of claim 1, wherein the upper magnetic seal includes a permanent magnet positioned adjacent an upper opening, the upper opening being between the permanent magnet and the housing cap, and wherein the lower magnetic seal includes a second permanent magnet positioned adjacent a lower opening, the lower opening being between the second permanent magnet and the core.

8. (canceled)

9. The TFD drum brake of claim 1, wherein a controller is capable of saturating the drum rotor with a magnetic flux generated by applying a current to the integrated coil.

10. The TFD drum brake of claim 1, further comprising:
a first brake shear surface on the drum rotor and a second brake shear surface on the drum rotor, wherein the first brake shear surface is on a rotor inner surface (RIS) of the drum rotor and the second brake shear surface is on a rotor outer surface (ROS) of the drum rotor;
a pole ring shear surface on a pole ring inner surface (PRIS) of the pole ring, the PRIS oppositely positioned from the ROS, wherein a first gap is positioned between the PRIS and the ROS; and
a core shear surface on a core outer surface (COS) of the core, the COS oppositely positioned from the RIS, wherein a second gap is positioned between the COS and the RIS.

11. The TFD drum brake of claim 1, wherein the drum rotor has a thickness between about 0.5 millimeters to about 5 millimeters.

12. (canceled)

13. The TFD drum brake of claim 1, wherein the first gap and the second gap each have a width of about 0.5 millimeters to about 2.0 millimeters.

14. (canceled)

15. (canceled)

16. (canceled)

17. A tactile feedback device (TFD) drum brake comprising:
a drum rotor having a first brake shear surface and a second brake shear surface, wherein the first brake shear surface is on a rotor inner surface (RIS) of the drum rotor and the second brake shear surface is on a rotor outer surface (ROS) of the drum rotor;
a pole ring having a pole ring shear surface on a pole ring inner surface (PRIS) fixedly and oppositely positioned from the ROS, wherein a second gap is positioned between the PRIS and the ROS;
a core having an integrated coil, the core having a core shear surface on a core outer surface (COS) oppositely positioned from the RIS, wherein a first gap is positioned between the COS and the RIS;
a rotation disk having an end, wherein the drum rotor is connected to the end and the rotation disk is rotatably connected to a shaft;
an upper magnetic seal;
a lower magnetic seal;
a magnetically responsive (MR) material disposed within the first gap and the second gap;
a housing enclosing the shaft, the drum rotor, the pole ring, the core, the rotation disk, the upper magnetic seal, and the lower magnetic seal, the housing including a housing cap secured to a housing wall at a housing top edge of the housing wall, and a sensor housing secured to the housing wall at a housing bottom edge of the housing wall;
wherein the upper magnetic seal is positioned to block movement of the MR material from the first gap past an upper void between the upper magnetic seal and the housing cap, and the lower magnetic seal is positioned to block movement of the MR material from the second gap past a lower void (86) between lower magnetic seal and the core; and
at least one sensor capable of detecting rotation of the shaft.

18. The TFD drum brake of claim 17, further comprising a controller and an external power source, wherein the controller is in electronic communication with the at least one sensor, the integrated coil, and the external power source, and the external power source is capable of generating a current, wherein the external power source in electrical communication with the integrated coil, wherein the controller is capable of controlling the current from the external power source and a magnetic flux generated by the integrated coil.

19. The TFD drum brake of claim 18, further comprising a circuit capable of saturating the drum rotor with the magnetic flux, wherein the circuit includes the core, the first gap with the MR material disposed therein, the drum rotor, the second gap with the MR material disposed therein, and the pole ring, wherein the drum rotor saturates when the magnetic flux passes through the circuit.

20. The TFD drum brake of claim 18, wherein the controller is integrally positioned within the sensor housing of the TFD drum brake.

21. The TFD drum brake of claim 20, wherein the controller includes a current amplifier and is capable of increasing or decreasing the current electrically communicated to the integrated coil.

22. (canceled)

23. The TFD drum brake of claim 17, wherein the upper magnetic seal includes a permanent magnet positioned adjacent an upper opening, the upper opening being between the permanent magnet and the housing cap, and wherein the lower magnetic seal includes a second permanent magnet positioned adjacent a lower opening, the lower opening being between the second permanent magnet and the core.

24. (canceled)

25. The TFD drum brake of claim 17, wherein the drum rotor has a thickness between about 0.5 millimeters to about 5 millimeters.

26. (canceled)

27. The TFD drum brake of claim 17, wherein the first gap and the second gap each have a width of about 0.5 millimeters to about 2.0 millimeters.

28. (canceled)

29. (canceled)

30. (canceled)

31. The TFD drum brake of claim 17, wherein the at least one sensor is capable of detecting a rotation of shaft.

32. A method of providing tactile feedback using a tactile feedback device (TFD) drum brake, the method comprising:
generating a torque with the TFD drum brake, the TFD drum brake including:
a drum rotor having a first brake shear surface and a second brake shear surface, wherein the first brake shear surface is on a rotor inner surface (RIS) of the drum rotor and the second brake shear surface is on a rotor outer surface (ROS) of the drum rotor;
a pole ring having a pole ring shear surface on a pole ring inner surface (PRIS) fixedly and oppositely positioned from the ROS, wherein a second gap is positioned between the PRIS and the ROS;
a core having an integrated coil, the core having a core shear surface on a core outer surface (COS) oppositely positioned from the RIS, wherein a first gap is positioned between the COS and the RIS;
a rotation disk having an end, wherein the drum rotor is connected to the end and the rotation disk is rotatably connected to a shaft;
an upper magnetic seal;
a lower magnetic seal;
a magnetically responsive (MR) material disposed within the first gap and the second gap;
a housing enclosing the shaft, the drum rotor, the pole ring, the core, the rotation disk, the upper magnetic seal, and the lower magnetic seal, the housing including a housing cap secured to a housing wall at a housing top edge of the housing wall, and a sensor housing secured to the housing wall at a housing bottom edge of the housing wall;
wherein the upper magnetic seal is positioned to block movement of the MR material from the first gap past an upper void between the upper magnetic seal and the housing cap, and the lower magnetic seal is positioned to block movement of the MR material from the second gap past a lower void (86) between lower magnetic seal and the core;
at least one sensor;
a controller in electronic communication with the at least one sensor;
a power source generating a current, the power source in electrical communication with the integrated coil, wherein the controller is capable of controlling the current from the power source and a magnetic flux generated as a result of the current being communicated to the integrated coil 54;
a circuit capable of saturating the drum rotor with the magnetic flux, wherein the circuit includes the core, the first gap with the MR material disposed therein, the drum rotor, the second gap with the MR material disposed therein, and the pole ring, wherein the drum rotor saturates when the magnetic flux passes through the circuit;
energizing the integrated coil by applying the current to the integrated coil, the energizing generating the magnetic flux;
magnetically saturating the drum rotor with the magnetic flux, wherein the magnetically saturating causes the first brake shear surface and the second brake shear surface of the drum rotor to shear against the MR material and each of the pole ring shear surface, and the core shear surface; and
generating a resistive torque, where in the shearing of the MR material against first brake shear surface, the second brake shear surface, the pole ring shear surface, and the core shear surface creates the resistive torque.
